(19) United States
(12) Patent Application Publication
(10) Pub. No.: US 2005/0050707 A1
(43) Pub. Date: Mar. 10, 2005

(54) Tip tool

(76) Inventors: Joshua Lynn Scott, Jordan, NY (US); Randy Howard Roberts, Cato, NY (US); Charles W. Fish III, Tully, NY (US)

Correspondence Address: WALL MARJAMA & BILINSKI, 101 SOUTH SALINA STREET, SUITE 400, SYRACUSE, NY, 13202, US

(21) Appl. No.: 10/656,738

(22) Filed: Sep. 5, 2003

(51) Int. Cl. B23P 19/04; B23P 19/00

(52) U.S. Cl. 29/426.5; 29/426.1; 29/428; 29/239

(57) ABSTRACT

A tip tool, and methods for using the tip tool to either connect or disconnect a tip to/from an imaging apparatus, are provided. The tip tool includes a body sized to fit over at least a portion of the tip and a tip holding element disposed in contact with the tip tool body for releasably engaging the tip.

### CROSS REFERENCE TO RELATED APPLICATIONS

None.

### FIELD OF THE INVENTION

The invention relates generally to methods and devices for connecting a tip to, or disconnecting a tip from, an imaging apparatus.

### BACKGROUND OF THE INVENTION

Modern digital inspection systems, such as borescopes and endoscopes of the type available from Everest VIT®, of Flanders, N.J., often employ insertion tubes or other devices to image locations that are remote or not easily, if at all, accessible. Such locations can include, but are not limited to, industrial targets, such as the interior of pressure vessels, turbines, reactors, and the like, or medical targets, such as within body lumens or surgical incisions among others. A distal end of such insertion tubes may be designed to employ a tip which contains various functional elements (usually optical), and which may be interchangeable and removably connected to the insertion tube. In the alternative, the tip may be intended for permanent affixation to the insertion tube.

When the tip is removably connected, one common method of connecting the tip to the insertion tube is by means of a threaded connection. Other methods also may be used, such as a friction fit, incorporation of compressible ribs, and the like. When permanently affixed, the tip may be held to the insertion tube by, for example, an adhesive or resin.

Current methods of attaching and/or detaching the tip require a person, such as a user or a technician, to secure the tip to the insertion tube by phalangeal manipulation or by using ill-suited tools, such as pliers and wrenches. All of these methods are deficient, for several reasons.

One reason is linked to the delicacy of the optical elements that often are included in such tips. An exemplary tip might include well-known components used in imaging devices, such as miniature electronic image sensors (of the type, for example, used in CCDs or CMOS-type imagers), mirrors, light sources (such as LEDs and laser diodes), and lenses. Thus dropping the tip, or worse, crushing the tip by using an inappropriate tool, may irreparably damage the optical elements of a tip or lose the tip altogether.

Depending on the imaging apparatus employing the tip, the tip also may be small, and difficult to manipulate by hand. For example, current tips may be as small as 3.9 millimeters (mm) in diameter, and less than 2 centimeters (cm) in length. For users with visual impairments, such as farsightedness, or for users operating in less than ideal conditions, such as in a sewer system or a dimly lit garage, accurately manipulating the optical tip may be difficult. In environments where protective gear or gloves are required, such as those dealing with hazardous substances or in medical/surgical procedures (in the case of an endoscope), manipulation of an optical tip may be even more unmanageable.

Touching the tip also may create problems, especially if dirt, chemicals, and/or oils from a fingertip or glove smudge the optical interface of the tip. Such inadvertent soiling of the tip may lead to degraded images and/or damaged tips.

### SUMMARY OF THE INVENTION

It is an object of this invention to provide methods and apparatus for attaching or removing a tip to an imaging apparatus that overcome the disadvantages of prior art methods and devices used to attach or remove such tips. A tip tool in accordance with the invention comprises a tip tool body sized to fit over at least a portion of the tip, and a tip holding element disposed in contact with the tip tool body for releasably engaging the tip.

Thus, in one aspect of the invention, a tip tool is provided which allows for attaching and/or detaching a tip to an insertion tube of an imaging apparatus.

In a further aspect of the invention, a tip tool is provided which allows for attaching and/or detaching a tip to an imaging apparatus without damaging the tip.

In yet another aspect of the invention, a tip tool is provided which allows for easy manipulation of the tip in poor lighting conditions.

In another aspect of the invention, a tip tool is provided which allows for accurate manipulation of a tip by a user when the user is wearing gloves or other protective gear.

In a further aspect of the invention, a tip tool is provided which allows for attaching and/or detaching a tip without soiling the tip.

In still another aspect of the invention, methods for attaching and/or detaching the tip to the insertion tube using a tip tool are provided.

These and other objects and features will be readily apparent from the following Detailed Description which should be read in conjunction with the accompanying drawings.

### BRIEF DESCRIPTION OF THE DRAWINGS

FIG. 1A is an exemplary imaging apparatus for use with a tip tool according to the present invention;

FIG. 1B is a side view of an exemplary tip of the imaging apparatus illustrated in FIG. 1A.

FIG. 2A is a side perspective view of a tip tool according to the present invention; and

FIG. 2B is a side perspective cutaway view of the tip tool of FIG. 2A.

### DETAILED DESCRIPTION OF THE PREFERRED EMBODIMENT

It is to be understood that the invention is not limited in its application to the details of construction and arrangements of components set forth herein in the detailed description of the preferred embodiment or illustrated in the drawings. The invention is capable of other embodiments and of being practiced or being carried out in various ways.

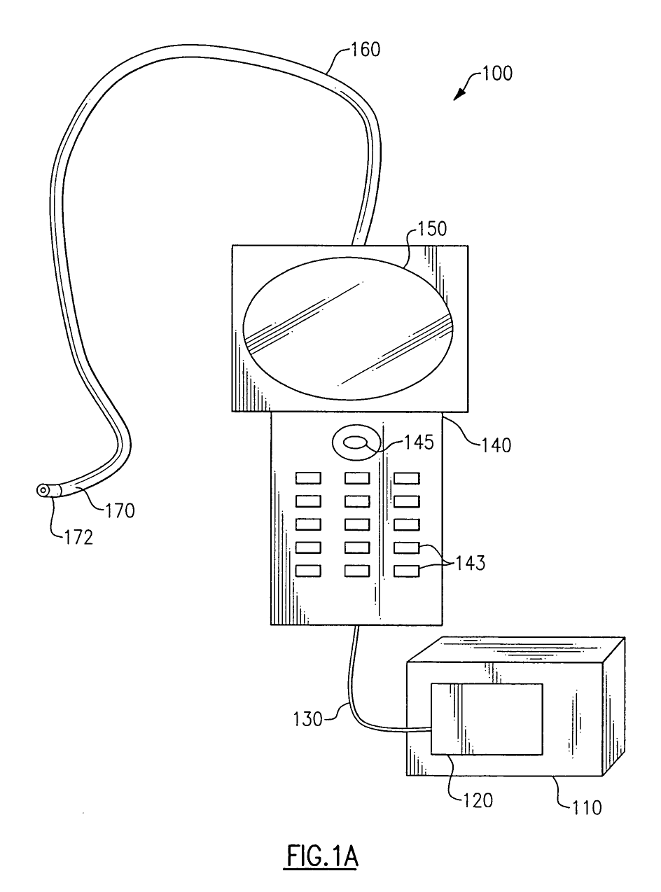

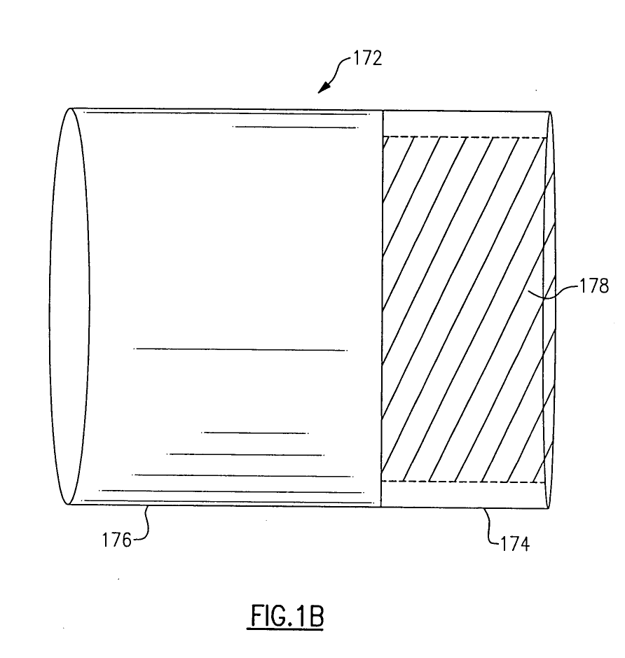

Referring to FIG. 1A, a typical imaging device 100 (a boroscope in the illustrative embodiment) according to the invention is illustrated, such as is sold by Everest VIT® of Flanders, N.J. Such a device could include, as shown in the illustrative embodiment, a portable shipping/operating case 110, which includes a power supply 120 for the device and a light source, such as a metal halide arc lamp (not shown). The shipping/operating case 100 is shown in operative communication with a handpiece 140 by means of a tethered cable 130. The handpiece 140 can include, by way of example, an LCD monitor 150 (which displays images seen by the imaging device 100), a user interface that includes a joystick control 145 (for articulating a distal end 170 of the imaging device 100), as well as a set of actuable or depressible buttons 143 (for accessing measurement and digital imaging controls associated with the imaging device 100). The handpiece 140 also is connected to an insertion tube 160, which terminates in a distal end 170. As used herein, the term “distal” shall mean “in the direction of the tip of the boroscope, furthest from the handpiece 140.” The distal end 170 of the insertion tube 160 is shown attached to a tip 172 (discussed in greater detail later). The insertion tube 160 can be sized according to the desired application, by varying a diameter and a length of the insertion tube 160. The insertion tube 160 can include, for example, a durable tungsten braid overlaying a stainless steel monocoil for crush resistance, and one or more layers of a polyurethane sealant for protection from liquids and vapors. The interior of the insertion tube 160 (not shown) can include standard imager lines and communication/control means, such as fiber-optic cables and articulation wires extending through the tube to the handpiece 140 permitting illumination from the light source and articulation control of the insertion tube via the joystick 145.

Referring to FIG. 1B, an exemplary tip 172 for use with a tip tool according to the present invention is illustrated. The tip 172 includes a proximal end 174 and an opposing distal end 176. The proximal end 174 includes, in the illustrative embodiment, a set of female threads 178, for mating to a set of male threads (not shown) provided on the distal end 170 of the insertion tube 160. The illustrative tip 172 shown has a diameter between about 3 mm and 10 mm, which is consonant with diameters used in borescope applications, though the tip tool can be varied in dimension and geometry, as appropriate, for use with tips of smaller or larger sizes. For purposes of illustration only, the tip 172 is defined by a substantially cylindrical configuration, though tips of any desired geometry may be used in connection with the tip tool of the present invention. Also, while the tip tool of the present invention can be used with tips containing a variety of components, the illustrative embodiment describes a tip 172 in which optical components, such as cameras and other imaging equipment, are disposed.

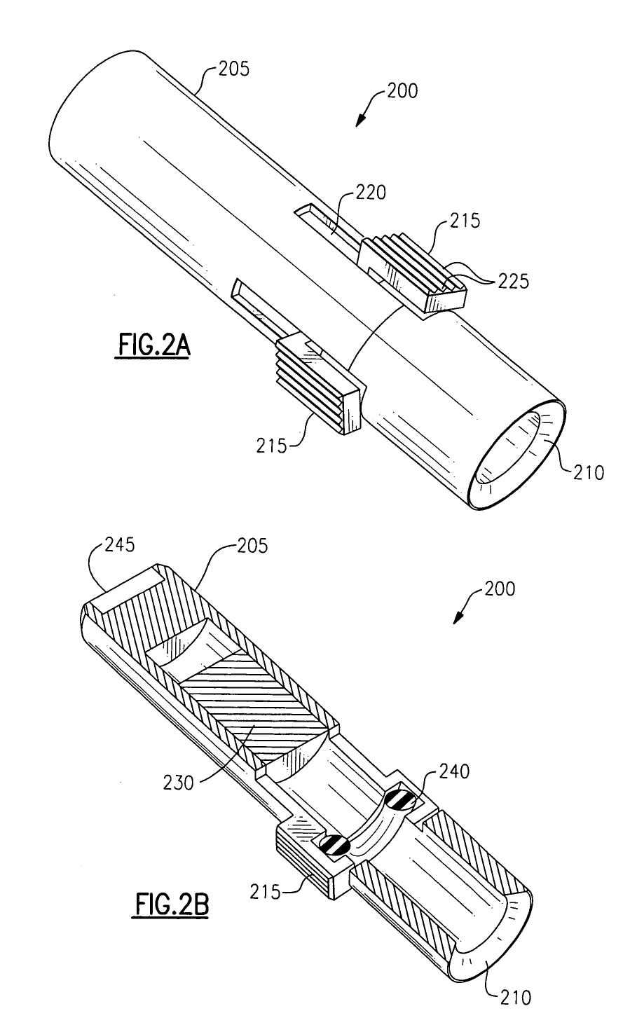

Referring to FIG. 2A and FIG. 2B, an exemplary tip tool 200 according to the present invention is illustrated. The illustrated tip tool 200 is shown as a generally cylindrical, hollow body, though tip tools in accordance with the present invention may be constructed with any desired geometry. For example, the geometry of the tip tool may selected based on the geometry of the tip to be manipulated, by ergonomic considerations, or by aesthetic preference.

Tip tool 200 includes a tip tool body 205. In the illustrative embodiment, the tip tool body 205 is machined from Delrin®, available from E.I. du Pont de Nemours and Co., though no particular material or manufacturing process is required to construct the tip tool of the present invention. Light weight, durable low wear, and low frictional property materials are preferred such as for the described embodiment, though other suitable materials may be selected, such as, for example, metals or ceramics. At one end of the tip tool body 205 is shown a tip tool opening 210. The tip tool opening 210 is sized so that a portion of a tip to be manipulated fits within the tip tool opening 210. As a consequence, the tip tool body 205 is sized so the tip tool body 205 fits over at least a portion of the tip to be manipulated. In the illustrative embodiment, the distal end 176 of the tip 172 shown in FIG. 1B is intended to fit into the tip tool opening 210 of the tip tool 200 shown in FIG. 2A and FIG. 2B.

The present invention contemplates a tip tool that releasably engages the tip to be manipulated. In the illustrative embodiment, this releasable engagement is accomplished by means of two tip holding elements, which will now be discussed in turn. The first tip holding element illustrated is an O-ring 240 disposed within the tip tool body 205, between the tip tool opening 210 and the depth set mechanism 230 (discussed below). The O-ring 240 illustrated is made from buna-n, which is a commercially available copolymer of butadiene and acrylonitrile, though other suitable materials, such as rubber or polymers other than buna-n, could be used.

The second tip holding element illustrated is a set of laterally extending arms 215. As shown in FIG. 2A, the arms 215 are cantilevered from the tip tool body 205, so that when compressed inward toward the tip tool body 205, the arms 215 deform inward. This cantilevered behavior of the arms 215 is accomplished in the illustrative embodiment by the presence of cutouts 220 in the tip tool body 205. In the illustrative embodiment, the arms 215 are made from the same material as the rest of the tip tool body 205 and machined in one piece with the tip tool body 205, though depending on the desired manufacturing process used to construct the tip tool 200, the arms could be created as separate elements, or made from separate materials. In such alternate situations, the arms could, for example, be coextruded in a single manufacturing step, or be attached to the tip tool body 205 in a second manufacturing step. The arms 215 of the illustrative embodiment can include knurled ridges 225 (shown in FIG. 2A). The ridges 225 provide a tactile feedback to a user of the tip tool 200, and allow for easier gripping of the arms 215 when the user is wearing gloves or other protective gear. In the illustrative embodiment, a pair of equally spaced arms 215 are provided on the exterior of the tool body 205, though the number of arms easily can be varied. For example, the arms could be formed as a single, ring-like member (not shown).

While two tip holding elements are illustrated herein, other tip holding elements are contemplated and are within the scope of the present invention. For example, deformable ribs or fins could be used to releasably engage the tip to be manipulated. In the alternative, pincers could be used to engage the tip. Another tip holding element could comprise a magnetized portion so that the tip is held for manipulation within the tip tool by magnetic attraction between the tip tool and the tip. The location of the tip holding element also may be varied without departing from the scope of the present invention. Thus, the desired tip holding element may be located, for example, within the tip tool body 205, outside the tip tool body 205, or disposed proximate the tip tool opening 210 of the tip tool 200. Environmental conditions, manufacturing costs, ergonomics, and aesthetics all may be considered when selecting an appropriate tip holding element and location.

As shown in FIG. 2B, the illustrative tip tool 200 according to the invention optionally also may include a depth set mechanism 230. The depth set mechanism 230 is sized to select how much of the tip to be manipulated will extend into the tip tool body 205 when the tip tool is engaged with the tip. In the illustrative embodiment, the depth set mechanism 230 is shown as a Delrin® plug, though the depth set mechanism could be accomplished by other means, and by using other suitable materials. For example, the depth set mechanism could comprise, instead of a plug, an adjustable stop allowing for setting various depths built into the tip tool body 205. Suitable materials for the depth set mechanism can include rubber, plastics, metals, and ceramics, so long as the chosen material will not damage the tip when the tip contacts the depth set mechanism (discussed below).

Referring to FIG. 1B, FIG. 2A, and FIG. 2B, in operation, when attaching a tip, such as the tip 172 illustrated in FIG. 11B, a user first orients the tip tool 200 toward the tip 172 such that the tip tool opening 210 is lined up with the tip 172. The tip tool 200 is then inserted over the tip 172, so that the distal end 176 of the tip 172 passes through the tip tool opening 210, and through the O-ring 240, thus releasably engaging the tip tool 200 with the tip 172. The tip tool 200 is inserted until the distal end 176 of the tip 172 contacts the depth set mechanism 230, thereby creating a resistance to further insertion, which the user detects. The user then manipulates the tip tool 200, as appropriate, to connect the tip 172 to the imaging apparatus, such as to the distal end of an insertion tube of an endoscope. In the illustrative embodiment, the user twists the tip tool 200 in a clockwise direction until the female threads 178 of the tip 172 have fully mated with the male threads of the imaging apparatus insertion tube.

When detaching the tip of the illustrative embodiment, the tip tool 200 is again inserted over the tip 172 in the manner described above, so that the tip 172 is releasably engaged with the tip 172. The user then inwardly compresses inward the arms 215 of the tip tool 200, thereby compressing the O-ring 240 against the tip 172, and twists the tip tool 200 in a counterclockwise direction until the female threads 178 of the tip 172 have disengaged from the male threads (not shown) of the imaging apparatus insertion tube.

The tip tool of the present invention is not limited to the threaded screw operation described in the illustrative embodiment. If, for example, the tip 172 is designed to be attached to the distal end 170 of the insertion tube 160 by means of a friction fit, a user could releasably engage the tip tool to the tip, and then use the tip tool of the present invention to push the tip toward the insertion tube 160 and onto the distal end 170 of the insertion tube 160. Similarly, a user could releasably engage the tip tool to a frictionally fitted tip, and then pull the tip away from the insertion tube 160 in order to remove the tip. Further, if a permanent affixture of the tip to the imaging apparatus is desired, the tip tool could be used, for example, in the manner described herein in conjunction with an adhesive or resin applied at the interface between the tip and the insertion tube 160.

By using the tip tool of the present invention, a user need never touch directly the tip being manipulated. Thus, the tip tool of the present invention allows for manipulation, attachment, and removal of a tip, without soiling the tip or damaging the tip, and without regard for a user's environmental conditions or garb.

In a further aspect of the invention, the tip tool 200 optionally can be used to store the removably engaged tip 172, thus offering a modicum of protection for the tip 172 when the tip 172 is not in use with the imaging apparatus. In addition, the tip tool 200 may be provided with identifying indicia, such as, for example, a color dot (such as color dot 245 in FIG. 2B) or text or other markings, to indicate to a user the preferred usage for a particular tip tool. Thus, for example, a tip tool intended for use with a 3.9 mm tip having a particular field of view can be readily differentiated (by means of the identifying indicia) from a tip tool intended for use with a 3.9 mm tip having a different field of view, or from a tip tool intended for use with a non-3.9 mm diameter tip.

While the invention has been described in conjunction with an illustrative embodiment, it is evident that numerous alternatives, variations, and modifications will be apparent to those skilled in the art in light of the foregoing description. Thus, it is understood that the invention is not to be limited by the foregoing illustrative details.

### Equivalents

While the invention has been particularly shown and described with reference to specific embodiments, it should be understood by those skilled in the art that various changes in form and detail may be made therein without departing from the spirit and scope of the invention as defined by the appended claims.

1. A tip tool for connecting or disconnecting a tip to an imaging apparatus, comprising:
a tip tool body sized to fit over at least a portion of the tip;
a tip holding element disposed in contact with the tip tool body for releasably engaging the tip.

2. The tip tool of claim 1, wherein the tip holding element is disposed within the tip tool body.

3. The tip tool of claim 1, wherein the tip holding element comprises an O-ring.

4. The tip tool of claim 3, wherein the O-ring is comprised of a polymer.

5. The tip tool of claim 4, wherein the polymer is buna-n.

6. The tip tool of claim 1, wherein the tip holding element comprises at least one compressible element.

7. The tip tool of claim 6, wherein the at least one compressible element comprises at least one arm cantilevered from the tip tool body.

8. The tip tool of claim 6, wherein the at least one compressible element comprises an O-ring.

9. The tip tool of claim 1, wherein the tip tool body is comprised of a polymer.

10. The tip tool of claim 9, wherein the polymer comprises Delrin®.

11. The tip tool of claim 7, wherein the at least one arm is comprised of the same material as the tip tool body.

12. The tip tool of claim 1, further comprising a depth set mechanism sized to select the extent to which the tip tool body is fitted over the at least a portion of the tip.

13. The tip tool of claim 1, wherein the tip tool is capable of storing the tip when the tip is not connected to the imaging apparatus.

14. The tip tool of claim 1, further comprising identifying indicia disposed at a visible location on the tip tool body.

15. A tool for connecting or disconnecting an optical tip to one of a borescope or endoscope, comprising:
a cylindrical, hollow body sized to fit over the optical tip;
an O-ring disposed within the body; and
at least one compressible arm cantilevered from the body,
wherein the at least one compressible arm is located over the O-ring so that when compressed the arm compresses the O-ring.

16. The tool of claim 15, wherein the O-ring is made from buna-n, and the body and the at least one compressible arm are each made from Delrin®.

17. A method for attaching a tip to an imaging apparatus, such as a borescope or endoscope, comprising the steps of:
grasping the tip with a tip tool;
manipulating the tip tool so as attach the tip to the imaging apparatus,
wherein the tip tool comprises a tip tool body and at least one tip holding element disposed in contact with the tip tool body for releasably engaging the tip.

18. The method of claim 17, wherein the step of manipulating the tip tool comprises turning the tip tool in a direction selected from the set of directions consisting of: clockwise and counterclockwise.

19. The method of claim 17, wherein the step of manipulating the tip tool comprises pushing the tip tool toward the imaging apparatus.

20. A method for detaching a tip from an imaging apparatus, such as a borescope or endoscope, comprising the steps of:
grasping the tip with a tip tool;
manipulating the tip tool so as detach the tip from the imaging apparatus,
wherein the tip tool comprises a tip tool body and at least one tip holding element disposed in contact with the tip tool body for releasably engaging the tip.

21. The method of claim 20, wherein the step of manipulating the tip tool comprises turning the tip tool in a direction selected from the set of directions consisting of: clockwise and counterclockwise.

22. The method of claim 20, wherein the step of manipulating the tip tool comprises pulling the tip tool away from the imaging apparatus.
